(19) United States
(12) Patent Application Publication
(10) Pub. No.: US 2026/0234073 A1
(43) Pub. Date: Aug. 13, 2026

(54) FERTILIZING COMPOSITION BASED ON RENEWABLE PHOSPHATE FERTILIZERS

(71) Applicant: AGWI, Saint Jouan des Guerets (FR)

(72) Inventors: Fabrice HOUDUSSE, Saint Malo (FR); Matthieu BÉZIAT, Saint Jouan des Guerets (FR)

(21) Appl. No.: 19/156,445

(22) PCT Filed: Jan. 30, 2024
(86) PCT No.: PCT/EP2024/052162

§ 371 Date: Aug. 14, 2025

(30) Foreign Application Priority Data
Feb. 15, 2023 (FR) 2301417

(51) Int. Cl. C05B 7/00; C05C 3/00; C05D 9/02; C05G 5/12

(52) U.S. Cl. CPC C05B 7/00; C05C 3/00; C05D 9/02; C05G 5/12

(57) ABSTRACT

The present invention concerns a fertilizing composition based on renewable phosphate fertilizers by proposing a composition that comprises struvite, at least two trace elements, at least one secondary element, and at least one clay.

### TECHNICAL FIELD

The present invention concerns a fertilizing composition based on renewable phosphate fertilizers.

### STATE OF THE ART

Phosphate is used massively as a chemical fertilizer in our agriculture. Every year, over 45 million tons of phosphate fertilizers are consumed worldwide to meet global food demand. Yet the phosphorus used in fertilizer production comes from non-renewable resources. In addition to its negative impact on mycorrhizae, the depletion of phosphorus resources poses a major risk to food security. With this in mind, it is imperative to find solutions to limit the use of non-renewable phosphate fertilizers.

In view of the above, there is a need for a fertilizing composition based on renewable phosphate fertilizers.

### DESCRIPTION OF THE INVENTION

Surprisingly, the inventors surprisingly found that the fertilizing composition according to the invention based on renewable phosphate fertilizers could improve plant nutrition more effectively than conventional phosphate fertilizers such as DAP (Diammonium phosphate) or struvite alone (see examples).

Struvite is a mineral of the hydrated phosphate family, specifically a double phosphate of ammonium and magnesium hexahydrate with the chemical formula NH₄MgPO₄. It is a naturally occurring mineral found in manure and guano, as well as in pathologies of the urine and renal tract.

Struvite comprises approximately per kilogram of crystalline struvite 126.2 g of phosphorus or 387.0 g of phosphate nitrogen and 57.1 g of nitrogen or 73.5 g of ammoniacal 99.0 g of magnesium.

Struvite poses a problem in wastewater treatment plants, as its crystals accumulate in pipes and reduce water flow. Currently, many methods exist to control struvite nucleation in wastewater treatment plants and reduce the amount of phosphate entering water bodies.

There is considerable interest in recycling phosphorus (P) in the form of struvite for environmental, economic and commercial reasons. Rather than generating waste for disposal, phosphate recovered in the form of struvite can be beneficially used as a fertilizer and also merits the designation “renewable fertilizer” because of its source.

An additional advantage of struvite is its limited solubility. The fertilizer dissolves over time to provide nutrients at a rate that plants can use. Highly soluble fertilizers tend to release nutrients at a faster rate than plants can absorb them, resulting in wasted fertilizer and negative environmental impacts.

Unfortunately, the use of struvite alone as a phosphate fertilizer is not as effective as conventional phosphate fertilizers. The present invention addresses this need by providing a struvite-based composition that improves plant nutrition more effectively than conventional phosphate fertilizers such as DAP or struvite alone (see examples).

The fertilizing composition according to the invention comprises struvite, at least two trace elements, at least one secondary element, and at least one clay.

The at least first and second trace elements may be selected from the group consisting of Manganese, Manganese sulfate, Iron, Zinc, Zinc oxide, Zinc sulfate, Copper, Molybdenum, Cobalt, Sodium chloride, potassium chloride, ferric sulfate, copper sulfate, cobalt chloride, chlorine, boron, nickel, vanadium, silicon, iron chelate, copper chelate, zinc chelate, manganese chelate, boron chelate, molybdenum chelate, selenium, sodium selenite, preferably molybdenum, nickel, copper, zinc, zinc oxide, manganese, boron, iron, selenium, sodium selenite and chlorine, more preferably zinc oxide and selenium or sodium selenite, even more preferably the first trace element is selenium and the second trace element is zinc oxide.

The at least one secondary element may be selected from the group consisting of urea, magnesium, magnesium carbonate, ammonium, ammonium chloride, ammonium molybdate, ammonium sulfate, magnesium oxide, magnesium chloride, ammonium nitrosulfate, potassium nitrate, ammonium sulfate, ammonium nitrate, calcium nitrate, potassium sulfate, monoammonium phosphate, potassium chloride, calcium chloride, calcium sulfate, magnesium sulfate, magnesium chloride, sodium chloride, diammonium phosphate, ammonium chloride, monocalcium phosphate, dicalcium phosphate, tricalcium phosphate, single superphosphate, triple superphosphate, zinc sulfate, iron sulfate, calcium phosphate, monopotassium phosphate, sodium nitrate, magnesium nitrate, potassium phosphate, potassium bicarbonate, potassium sulfite, calcium sulfate, potassium oxide, ammonium phosphate, magnesium oxide, polyphosphate, ammonium sulfamate, ammonium carbonate, sulfur, potassium carbonate, potassium hydrogen phosphate, preferably ammonium sulfate.

The at least one clay may be selected from the group consisting of sepiolite, bentonite, kaolinite, illite, montmorillonite, vermiculite, halloysite, attapulgite, saponite, chlorite, mica, illite-montmorillonite, smectite, heulandite and mixtures thereof, preferably sepiolite.

According to one embodiment, the fertilizing composition according to the invention comprises
between 5% and 98.9%, between 25% and 98%, between 50% and 97.5%, between 75% and 97%, between 85% and 96%, or between 87% and 94%, preferably between 88% and 92% by weight of struvite
between 0.005% and 10%, between 0.01% and 5%, between 0.025% and 2.5%, or between 0.05% and 1%, preferably between 0.1% and 0.55% by weight of a first trace element;
between 0.005% and 10%, between 0.01% and 5%, between 0.05% and 4%, or between 0.1% and 3%, preferably between 0.5% and 2.8% by weight of a second trace element;
between 0.25% and 10%, between 0.5% and 5%, or between 0.75% and 4.5%, preferably between 1% and 4% by weight of a secondary element; and
between 0.1% and 10%, between 0.25% and 5%, or between 0.5% and 3%, preferably between 0.6% and 2.6% by weight of at least one clay.

According to a preferred mode of the invention, the fertilizing composition according to the invention comprises between 5% and 98.9%, between 25% and 98%, between 50% and 97.5%, between 75% and 97%, between 85% and 96%, or between 87% and 94%, preferably between 88% and 92% by weight of struvite; between 0.005% and 10%, between 0.01% and 5%, between 0.025% and 2.5%, or between 0.05% and 1%, preferably between 0.1% and 0.55% by weight of selenium; between 0.005% and 10%, between 0.01% and 5%, between 0.05% and 4%, or between 0.1% and 3%, preferably between 0.5% and 2.8% by weight of zinc oxide; between 0.25% and 10%, between 0.5% and 5%, or between 0.75% and 4.5%, preferably between 1% and 4% by weight of ammonium sulfate; and between 0.1% and 10%, between 0.25% and 5%, or between 0.5% and 3%, preferably between 0.6% and 2.6% by weight of sepiolite.

According to one embodiment, the fertilizing composition according to the invention is in the form of a powder, an emulsion in water, or in granulated form, preferably in granulated form.

Preferably, the fertilizing composition is applied at a rate of 2.5 to 500 kg/ha, 5 to 200 kg/ha, 10 to 100 kg/ha, preferably 15 to 50 kg/ha.

According to one embodiment, the fertilizing composition according to the invention further comprises between 0.1% and 15% by weight of at least one mycorrhizal fungus.

Surprisingly, the inventors determined that using the composition according to the invention in combination with at least one mycorrhizal fungus made it possible to ensure and improve plant nutrition by increasing the phosphorus content in plants while promoting the development of mycorrhizae, in contrast to the use of conventional phosphate fertilizers such as DAP or struvite alone.

In a preferred embodiment, the mycorrhizal fungus is selected from the group consisting of an arbuscular mycorrhizal fungus, an ecto-mycorrhizal fungus, an ectendo-mycorrhizal fungus and an ericoid mycorrhizal fungus or a combination thereof.

Arbuscular mycorrhizal fungi are characterized by their intracellular growth in plant cells, where they form arbuscules and vesicles. Arbuscules are highly branched, tree-like structures that contribute to the exchange of carbon and nutrients such as nitrogen and phosphate. Vesicles are bladder-shaped structures that are thought to store nutrients. Shrubby mycorrhizal fungi form underground fruiting bodies. Preferred embodiments include, but are not limited to, Glomus mosseae and Glomus intraradices.

Ecto-mycorrhizal fungi do not form arbuscules and vesicles. Instead, ecto-mycorrhizal fungi grow around and inside roots, where they form a specific structure known as a “salt net”. The fungal threads that form the Hartig net develop intercellularly. As they grow around the roots, ecto-mycorrhizal fungi form a layer around the root. The color and shape of the layer may vary depending on the species of ecto-mycorrhizal fungi. In the Hartig network, there is an exchange of nutrients, particularly nitrogen, phosphate and carbon. The ecto-mycorrhizal fungi form aerial fruiting bodies. Preferred embodiments include, but are not limited to, Laccaria laccata, Boletus edulis, Cantharellus cibarius and Paxillus involutus.

Ectendo-mycorrhizal fungi are characterized by their absence of arbuscules and vesicles, and their intracellular development in root cells. Ectendomycorrhizal fungi also form a so-called “salt net”, but this is much thinner than with ecto-mycorrhizal fungi. Ectendomycorrhizal fungi can form an aerial fruiting body. Preferred embodiments include, but are not limited to, Tuber, Tricharlna and Wilcoxina species.

Ericoid mycorrhizal fungi are characterized by intracellular growth in root cells. Ericoid mycorrhizal fungi do not form layers, Hartig nets, arbuscules or vesicles. Ericoid mycorrhizal fungi form characteristic curved structures. Preferred embodiments include, but are not limited to, Hymenoscyphus ericae, Rhizoscyphus spp, and Oidiodendron spp.

The above-mentioned mycorrhizal fungi, in particular a combination of different mycorrhizal fungi or different types of mycorrhizal fungi are suitable according to the invention. In particular, these combinations have an advantageous effect due to the compatibility that occurs between the different species. The overlap of non-matching properties such as cold tolerance, adaptation to soil conditions, tolerance to drought or waterlogging or cooperation with the plant species of choice leads to an advantage when using different species or different types of mycorrhizal fungi.

According to one embodiment, the fertilizing composition according to the invention is comprised in or consists of the core of a granular fertilizer.

According to one embodiment, the final product to be applied to the soil is the blended or granulated combination of the composition according to the invention with additional raw materials.

The fertilizing composition according to the invention may also comprise or be combined with other components chosen, for example, from among binders, additives, fillers and minerals.

The fertilizing composition may comprise or be combined with, without limitation: ammonium sulfate, ammonium nitrate, ammonium sulfate nitrate, ammonium chloride, ammonium bisulfate, ammonium polysulfide, ammonium thiosulfate, aqueous ammonia, anhydrous ammonia, ammonium polyphosphate, aluminum sulfate, calcium nitrate, calcium ammonium nitrate, sulfate, calcined magnesite, calcitic limestone, calcium oxide, calcium nitrate, dolomitic limestone, hydrated lime, calcium carbonate, diammonium phosphate, monoammonium phosphate, magnesium nitrate, magnesium sulfate, potassium nitrate, potassium chloride, potassium carbonate, potassium and magnesium sulfate, potassium sulfate, sodium nitrate, magnesian limestone, magnesia, urea, urea formaldehydes, urea ammonium nitrate, sulfur-coated urea, polymer-coated urea, isobutylidene diurea, K2SO4-2MgSO4, kainite, sylvinite, kieserite, Epsom salts, elemental sulfur, marl, ground oyster shells, fish meal, fish cakes, fish manure, blood meal, phosphate rock, super phosphates, slag, bone meal, fish wood, manure, bat guano, peat moss, compost, greensand, cottonseed cake, feather meal, crab meal, fish emulsion, amino acid hydrolysates, sugars, organic acids, diamines and polyamines, humic extracts, organic soil improvers, biostimulants, algae extracts, plant extracts, live microorganisms, microorganism extracts or a combination thereof.

Preferably between 0% and 80%, more preferably between 0% and 70%, more preferably between 0% and 50% by weight of the above compounds is present in the combination resulting from said compound(s) with the fertilizing composition according to the invention.

According to another aspect of the invention, the fertilizing composition according to the invention is combined with at least one other complementary fertilizer selected from nitrogen fertilizers, potassium fertilizers, phosphate fertilizers, binary fertilizers (NP,PK) and ternary fertilizers (NPK) and combinations thereof, and optionally in association with calcium amendments, boric acid, leonardite, organic soil amendments and feldspar, one or more biostimulants selected from the group consisting of amino acid hydrolysates, humic extracts, algae extracts, plant extracts, live microorganisms, microorganism extracts and combinations thereof.

Said combination of the fertilizing composition according to the invention with at least one other complementary fertilizer can be used in granulated, emulsion or powder form, preferably in that it is applied at a rate of 2.5 to 500 kg/ha, 5 to 200 kg/ha, 10 to 100 kg/ha, preferably 15 to 50 kg/ha.

According to one embodiment, the sugars are chosen from mono- and di-saccharides, preferably sucrose, fructose, trehalose, glucose, arabinose, maltose, as well as mixtures thereof.

According to one embodiment, the amino acids are selected from threonine, lysine, phenylalanine, glutamic acid, methionine, GABA, ornithine, glycine, glutamine, aspartic acid, serine, asparagine, tyrosine, tryptophan, valine, leucine, isoleucine, proline, 4-hydroxyproline, arginine, histidine, alanine, cysteine and mixtures thereof.

According to one embodiment, the organic acids are selected from lactic acid, succinic acid, oxalic acid, gluconic acid, threonic acid, fumaric acid, syringic acid and mixtures thereof.

According to one embodiment, the diamines and polyamines are selected from cadaverine, putrescine, spermidine, spermine and mixtures thereof.

In one embodiment, the organic amendment is selected from cattle, sheep, pig, mink, rabbit and chicken droppings.

According to one embodiment, the living microorganisms or microorganism extracts are selected from the family of Thiorhodaceae, Athiorhodaceae, Chlorobacteriaceae, Nitrobacteriaceae preferably from the genus Nitrosomonas or Nitrobacter, Thiobacteriaceae preferably from the genus Thiobacillus, Methanomonadaceae preferably from the genus Hydrogenomonas, Carboxydomonas or Methanomonas, Caulobacteriaceae, Siderocapsaceae, Pseudomonaceae preferably from the genus Pseudomonas, Xanthomonas, Acetobacter or Azotomonas, Spirillaceae preferably from the genus Vibrio, Cellvibrio, Cellfalcicula, Desulfovibrio or Spirillum, Azotobacteriaceae preferably from the genus Azotobacter, Beijerinckia or Derxia, Rhizobacteriaceae preferably from the genus Rhizobium, Chromobacterium or Agrobacterium, Achrobacteriaceae preferably from the genus Achromobacter or Flavobacterium, Enterobacteriaceae preferably from the genus Escherichia, Proteus, Aerobacter or Serratia, Micrococcaceae preferably from the genus Micrococcus or Sarcina, Brevibacteriaceae preferably from the genus Brevibacterium, Lactobacillus preferably from the genus Streptococcus, Leuconostoc or Lactobacillus, Corynebacteriaceae preferably from the genus Corynebacterium, Cellulomonas or Arthrobacter, Bacillaceae preferably from the genus Bacillus or Clostridium, and mixtures thereof. Preferably, the live microorganisms or microorganism extracts are selected from the species Pichia guilliermondii, Azotobacterchroococcum, Azotobacter vinelandii, Azospirillum lipoferum, Bacillus megaterium, Bacillus aryabhattai, Bacillus amiloliquefaciens, Bacillus licheniformis and Oceanobacillus picturae, and mixtures thereof.

According to another aspect of the invention, the invention relates to a method of fertilization comprising the application of the fertilizing composition according to the invention on or in the soil, preferably wherein said composition according to the invention is applied at a rate of 2.5 to 500 kg/ha, 5 to 200 kg/ha 10 to 100 kg/ha, preferably 15 to 50 kg/ha.

According to one embodiment, the soil fertilization method comprises the application of the fertilizing composition according to the invention on or in the soil for the cultivation of leaf vegetables, fruit vegetables, root vegetables, cereals, flowers, ornamental crops or vegetable crops, preferably for the cultivation of maize, potatoes, beet, rapeseed, sunflower, soybeans, lettuce or turf.

According to another aspect of the invention, the object of the invention is to use the fertilizing composition according to the invention for the cultivation of leafy vegetables, vegetables fruit, root vegetables, cereals, flowers, ornamental crops or vegetable crops, preferably for the cultivation of maize, potatoes, beet, rape, sunflower, soya, lettuce or turf.

For example, the use of a fertilizer for the cultivation of tuberous plants such as potatoes, or leafy plants such as lettuce.

### BRIEF DESCRIPTION OF FIGURES

FIG. 1 Dry weight of soybean roots at BBCH 10, 13 days after application of treatments.

FIG. 2 Phosphorus concentration in soybean leaves at BBCH 15.

FIG. 3 Soybean yield in T/Ha.

FIG. 4 Dry above-ground biomass of lettuce (average g/plant).

### EXAMPLES

### Example 1: Effect of Fertilizing Composition According to the Invention on Growth, Nutrient Uptake and Yield of Soybean

### Materials and Methods

Crop: soybean, commercial variety top 5
5 randomized complete block replicates
N and K fertilization: conventional fertilization
Homogeneous crop and soil (pH 6.5)

TABLE 1
Composition C1 according to the invention

| Composition C1 according | |
|---|---|
| to the invention: | % by weight |
| Struvite | 90% |
| Zinc oxide | 2.6% |
| Selenium | 0.5% |
| Ammonium sulfate | 4% |
| Sepiolite | 2.9% |

TABLE 2
Trial conditions

| Treatment | Product | Rate | Scale BBCH |
|---|---|---|---|
| 1 | Untreated control | | |
| 2 | DAP | 100 kg/ha | BBCH 00 - sowing |
| 3 | Composition C1 | 25 kg/ha | BBCH 00 - sowing |
| | according to the | | |
| | invention | | |

TABLE 3
Soybean plant analyses

| | |
|---|---|
| Establishment | Emergence |
| | Root development |
| All cycles | General observation (PHYGEN % - |
| | Percentage of plants exhibiting |
| | phytotoxicity, VIGOR % - Plant vigor at at |
| | the early growth stage) and photographs, |
| | special assessment of Phosphorus |
| | deficiency at 5-leaf stage. |
| Harvest | General observation and photographs |
| | Harvest yield (all plots) and TKW |
| | (Thousand Kernel Weight) |

### Results

Application of the products (C1, DAP) did not induce phytotoxicity on the plant, and emergence vigor was similar for all treatments (data not shown).

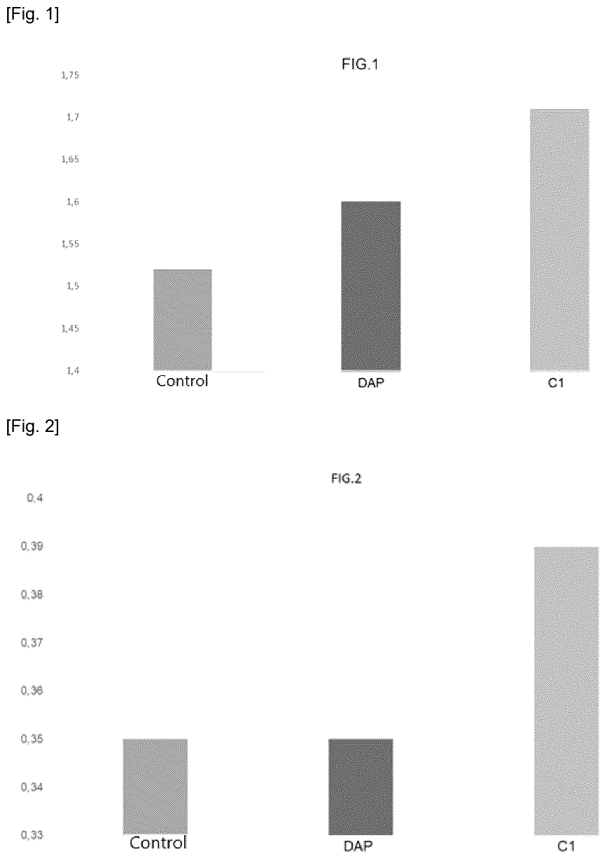

At BBCH 11 (13 days after application of the treatments), we observed a strong increase in root biomass in the C1-treated plant compared with DAP and the untreated plant (+6.8% and +12.5% respectively) (see FIG. 1). Differences were significant at p=0.05.

Interestingly, the increase in root growth induced a higher concentration of phosphorus in the leaves (see FIG. 2) in the C1-treated plant, showing that the form of phosphorus in C1 is rapidly available when applied very close to the seed.

The good start-up effect of the C1 composition on the soybean resulted in a better final yield (see FIG. 3) compared with the untreated (+250 kg/ha, +5.6%). We also observed a better yield compared to DAP (+110 kg).

TABLE 4
Final soybean yield

| | | | YIELD |
|---|---|---|---|
| Name | Rate | Unit | (T/Ha) |
| Untreated | | | 4.81 |
| control | | | |
| DAP | 100 | kg/ha | 4.95 |
| C1 | 25 | kg/ha | 5.06 |

### Example 2: Study of the Effects of a Microgranulated Solid Starter Fertilizer According to the Invention on Lettuce Growth, Compared with Pure Struvite

The trial was conducted on the Kyra lettuce variety. Seeds were sown in a 6-well plate containing a seedbed potting soil (GOM8) and placed in favorable conditions to initiate germination.

Two weeks after sowing, the most homogeneous seedlings were potted into 4 L pots containing a 50/50 potting mix. The pots were then placed in a greenhouse for the rest of the trial.

A nutrient solution was applied to all modalities one week after repotting. Fertilization was optimal for all modalities. The products were applied to the soil, in contact with the root ball at the time of potting (see modalities table).

TABLE 4
Test methods

| Modalities | Product | Dosage | Stage |
|---|---|---|---|
| Control | — | — | — |
| M1 | Struvite | 25 kg/ha (equivalent) | BBCH00 |
| M2 | C1 (see example 1) | 25 kg/ha (equivalent) | BBCH00 |

Statistical analysis (with ANOVA p-value reported) of the dried biomass:

### Results

TABLE 5
Average dry biomass in g/plant

| | Dry biomass (average |
|---|---|
| | g/plant) |
| Control | 4.92 |
| Struvite | 4.79 |
| C1 | 5.54 |

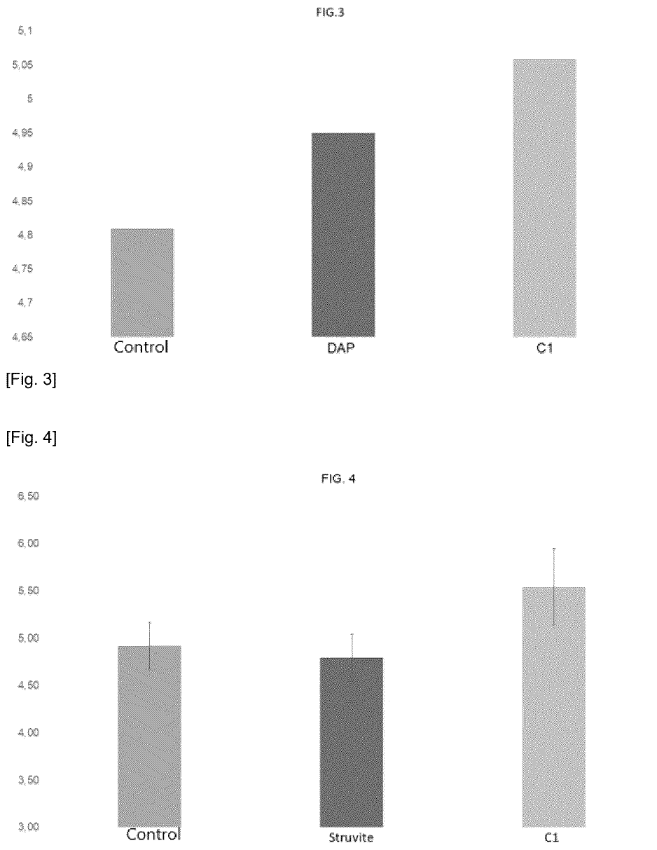

Composition C1 according to the invention significantly (p=0.1%) increased dry biomass production compared with the control and struvite (see FIG. 4).

1. A fertilizing composition comprising struvite, at least one first and one second trace element, at least one secondary element, and at least one clay.

2. The fertilizing composition according to claim 1, comprising:
from about 5% to about 98.9% by weight of struvite;
from about 0.005% to about 10% by weight of a first trace element;
from about 0.005% to about 10% by weight of a second trace element;
from about 0.25% to about 10% by weight of a secondary element; and
from about 0.1% to about 10% by weight of at least one clay.

3. The fertilizing composition according to claim 1 or 2, wherein the at least first and second trace elements are independently selected from the group consisting of Manganese, Manganese sulfate, Phosphorus, Iron, Zinc, Zinc oxide, zinc sulfate, copper, molybdenum, cobalt, sodium chloride, ammonium chloride, ammonium molybdate, ammonium sulfate, potassium chloride, ferric sulfate, copper sulfate, cobalt chloride, chlorine, boron, nickel, vanadium, silicon, iron chelate, copper chelate, zinc chelate, manganese chelate, boron chelate, molybdenum chelate, selenium, sodium selenite, preferably molybdenum, nickel, copper, zinc, zinc oxide, manganese, boron, iron, selenium, sodium selenite and chlorine, more preferably zinc oxide and selenium or sodium selenite, even more preferably the first trace element is selenium and the second trace element is zinc oxide.

4. The fertilizing composition according to claims 1 to 3, wherein the at least one secondary element can be selected from the group consisting of urea, magnesium, magnesium carbonate, magnesium oxide, magnesium chloride, ammonium nitrosulphate, potassium nitrate, ammonium sulfate, ammonium nitrate, calcium nitrate, potassium sulfate, monoammonium phosphate, potassium chloride, calcium chloride, calcium sulfate, magnesium sulfate, magnesium chloride, sodium chloride, diammonium phosphate, ammonium chloride, monocalcium phosphate, dicalcium phosphate, tricalcium phosphate, single superphosphate, triple superphosphate, zinc sulfate, iron sulfate, calcium phosphate, monopotassium phosphate, sodium nitrate, magnesium nitrate, potassium phosphate, potassium bicarbonate, potassium sulfite, calcium sulfate, potassium oxide, ammonium phosphate, magnesium oxide, polyphosphate, ammonium sulfamate, ammonium carbonate, sulfur, potassium carbonate, potassium hydrogen phosphate, preferably ammonium sulfate.

5. The fertilizing composition according to claims 1 to 4, wherein the at least one clay is selected from the group consisting of sepiolite, bentonite, kaolinite, illite, montmorillonite, vermiculite, halloysite, attapulgite, saponite, chlorite, mica, illite-montmorillonite, smectite, heulandite and mixtures thereof, preferably sepiolite.

6. The fertilizing composition according to any one of claims 1 to 5, wherein it is in powder form, in the form of an emulsion in water or in granulated form, preferably in granulated form.

7. A method of fertilizing soil comprising applying the fertilizing composition according to any one of claims 1 to 6 on or in the soil.

8. The method according to claim 7, wherein said fertilizing composition is applied at a rate of 2.5 to 500, 5 to 200 kg/ha, 10 to 100 kg/ha, preferably 15 to 50 kg/ha.

9. Use of the fertilizing composition according to any one of claims 1 to 6 for the cultivation of leaf vegetables, fruit vegetables, root vegetables, cereals, flowers, ornamental crops, and vegetable crops, preferably for the cultivation of maize, potatoes, beet, rape, sunflower, soya, lettuce or turf.
